(19) United States
(12) Patent Application Publication
(10) Pub. No.: US 2006/0246252 A1
(43) Pub. Date: Nov. 2, 2006

(54) Optical recording medium

(75) Inventor: Chin-Chih Wang, Taipei Hsien (TW)

Correspondence Address: BIRCH STEWART KOLASCH & BIRCH, PO BOX 747, FALLS CHURCH, VA, 22040-0747, US

(73) Assignee: PRODISC TECHNOLOGY INC.

(21) Appl. No.: 11/178,399

(22) Filed: Jul. 12, 2005

(30) Foreign Application Priority Data
Apr. 29, 2005 (TW) 094114010

(51) Int. Cl. B32B 3/02

(52) U.S. Cl. 428/64.4

(57) ABSTRACT

An optical recording medium includes a substrate, a reflective layer, a first printing layer and a second printing layer. In this case, the reflective layer is disposed above the substrate. The first printing layer is disposed above the reflective layer. The second printing layer is disposed on the first printing layer. The first printing layer and the second printing layer comprise translucent ink, and the first printing layer further comprises white ink.

### BACKGROUND OF THE INVENTION

1. Field of Invention

The invention relates to an optical recording medium and, in particular, to a printable optical recording medium.

2. Related Art

Due to the progress of multimedia, the demands of storage medium in 3C products, i.e. computer, communication and consumer, regarding to storage density and capacity are increasing. Conventional storage medium could be divided into magnetic information storage medium and optical information storage medium. Optical information storage medium is greatly applied to electronic products, it includes read-only CD (CD-ROM), write-once CD (CD-R), rewritable CD (CD-RW), read-only DVD (DVD-ROM), write-once DVD (DVD-R), rewritable DVD (DVD-RW, DVD+RW) and random-access DVD (DVD-RAM), etc.

To attract costumers' attention, the manufacturers of optical recording media work hard on the development of attractive products, which can increase the market share. Therefore, some manufacturers disclose a printable optical recording medium. The customer can print his/her favorite picture or words on the surface of the optical recording medium with a printer. Regarding to the entertainment effect, the printed picture or words are better than the sticker or the written words with an oil-based marker. Besides, the optical recording medium with the printed picture or words is integral and similar to the sold CD. Thus, it can provide better entertainment and uniqueness so as to cause the purchases of customers.

With reference to FIG. 1, a conventional printable optical recording medium 10, such as a CD-ROM, includes a substrate 11, a reflective layer 12, a protective layer 13, a first printing layer 14 and a second printing layer 15. The substrate 11 having pre-grooves is made of polycarbonate and is formed with an injection molding machine. The reflective layer 12 is disposed over the substrate 11 and is made of metal or alloy such as silver or silver alloy, aluminum or aluminum alloy, or gold or gold alloy. The reflective layer 12 is usually formed by sputtering or evaporation. The optical recording medium 10 can reflect a laser beam with the reflective layer 12, and then the digital data recorded in the optical recording medium 10 can be read. To protect the reflective layer 12 from oxidation or being scratched, the protective layer 13 is usually disposed on the reflective layer 12. The protective layer 13 is made of acrylic resin monomer. After irradiated with UV light, the acrylic resin monomer can be polymerized and hardened so as to protect the reflective layer 12.

After that, a halftone printing process is performed to print UV ink on the protective layer 13. The UV ink is irradiated with UV light to form the first printing layer 14. In general, the first printing layer 14 mainly comprises white UV ink, so that the surface of the optical recording medium 10 can present white color. Accordingly, the customer can print picture or words on the surface of the optical recording medium with better contrast.

Finally, another halftone printing process is performed to print translucent ink on the first printing layer 14. The translucent ink is irradiated with UV light to form the second printing layer 15. In general, the second printing layer 15 is made of translucent ink, which can absorb ink. The thickness of the second printing layer 15 is about 20 μm.

However, it takes 30 to 60 seconds to wait the ink being dried after the ink is printed on the second printing layer 15 of the conventional printable optical recording medium 10. The waiting period of 30 to 60 seconds is too long for the customer. Therefore, if the waiting period for drying the ink can be reduced, the product competitiveness can be increased.

It is therefore an important subject of the invention to provide an optical recording medium, which can reduce the drying time of ink.

### SUMMARY OF THE INVENTION

In view of the foregoing, the invention is to provide an optical recording medium that can reduce the drying time of ink.

To achieve the above, an optical recording medium of the invention includes a substrate, a reflective layer, a first printing layer and a second printing layer. The reflective layer is disposed above the substrate. The first printing layer is disposed above the reflective layer and comprises translucent ink and white ink. The second printing layer is disposed on the first printing layer and comprises translucent ink.

As mentioned above, the optical recording medium of the invention has a first printing layer composed of white ink and translucent ink and a second printing layer composed of translucent ink. Compared with the prior art, the invention changes the materials of the first and second printing layer of the optical recording medium for reducing the drying time of ink. Thus, the whole competitiveness of the product can be enhanced to attract customers, so the sales volume of the manufacture can increase.

### BRIEF DESCRIPTION OF THE DRAWINGS

The invention will become more fully understood from the detailed description given herein below illustration only, and thus is not limitative of the present invention, and wherein:

FIG. 1 is a schematic view showing the conventional printable optical recording medium; and

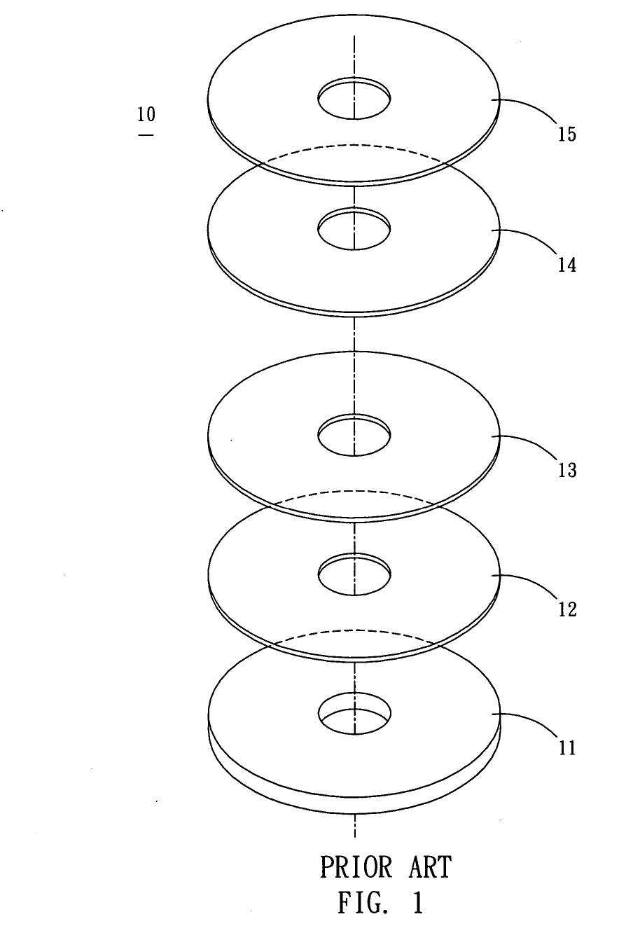

FIG. 2 is a schematic view showing an optical recording medium according to a preferred embodiment of the invention.

### DETAILED DESCRIPTION OF THE INVENTION

The present invention will be apparent from the following detailed description, which proceeds with reference to the accompanying drawings, wherein the same references relate to the same elements.

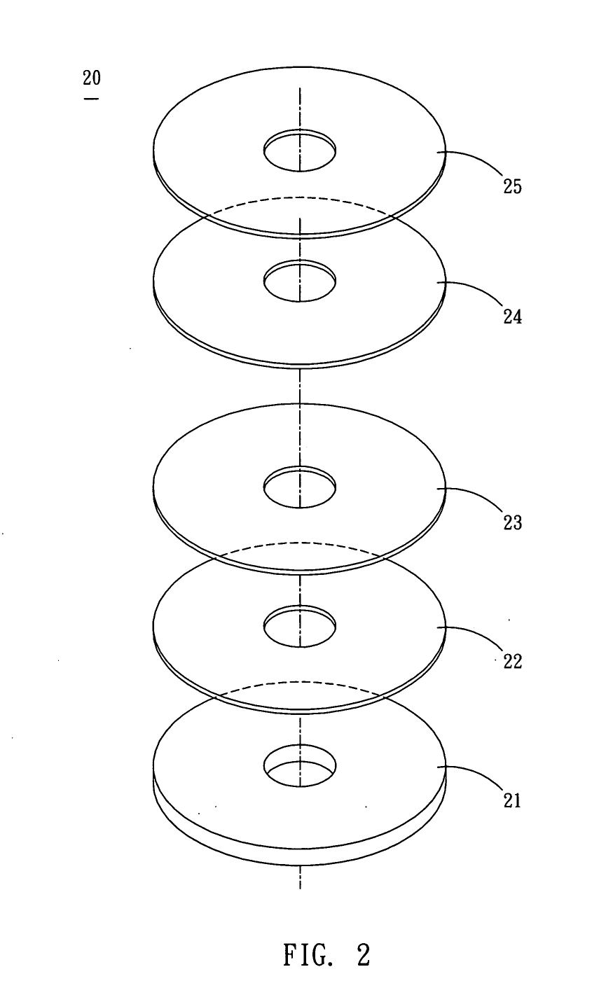

With reference to FIG. 2, an optical recording medium 20 according to a preferred embodiment of the invention includes a substrate 21, a reflective layer 22, a protective layer 23, a first printing layer 24 and a second printing layer 25.

In the invention, the optical recording medium can be a CD-ROM, a CD-R, a CD-RW, a DVD-ROM, a DVD+/−R, a DVD+/−RW, or a DVD-RAM. In this embodiment, the optical recording medium 20 is, for example, a CD-ROM.

The substrate 21 is, for example, a transparent substrate made of plastic materials such as acrylic, polycarbonate (PC), or acrylonitrile-butadiene-styrene (ABS). For forming the substrate 21, the plastic material is applied in an injection molding process with a stamper having data pits and grooves.

The reflective layer 22 is disposed on the substrate 21. In the current embodiment, the reflective layer 22 is made of metal or alloy, such as silver or silver alloy, aluminum or aluminum alloy, gold or gold alloy, semiconductor alloy film, and the likes. The reflective layer 22 is usually formed by sputtering or evaporation. Furthermore, a protective layer 23 can be provided between the first printing layer 24 and the reflective layer 22 for preventing the reflective layer 22 from being scratched.

The first printing layer 24 is disposed on the reflective layer 22 and is mainly composed of white ink and translucent ink. In this embodiment, the white ink at least includes acrylate, trimethylolpropane triacrylate (TMPTA), tripropyleneglycol diacrylate (TPGDA), and benzoin ether. Besides, the translucent ink of the embodiment at least includes acrylic, urethane acrylate, ether, aliphatic cyclic monomer, and photo initiator.

In this case, the white ink and the translucent ink are mixed in advance, and the white ink is about 50% to 70% of the mixed ink. The mixed ink is printed onto the protective layer 23 and is then irradiated with UV light so as to form the first printing layer 24. Since the first printing layer 24 is white, the customer can print picture or words on the surface of the optical recording medium 20 with better contrast and plentiful color. Moreover, since the mixed ink contains white ink and translucent ink, the first printing layer 24 can facilitate the absorption of printed ink so as to reduce drying time of the printed ink.

In the present embodiment, the second printing layer 25 is disposed on the first printing layer 24 and is used for absorbing the printed ink ejected from the printer. In this case, the second printing layer 25 is mainly composed of translucent ink. To form the second printing layer 25, the translucent ink is printed onto the first printing layer 24 and is then irradiated with UV light. The translucent ink at least includes acrylic, urethane acrylate, ether, aliphatic cyclic monomer, and photo initiators. To be noted, the thickness of the second printing layer 25 may greater than 30 μm. Accordingly, the drying time (about 10 seconds) of the ink printed on the surface of the optical recording medium 20 can be efficiently shortened.

In summary, the optical recording medium of the invention has a first printing layer composed of white ink and translucent ink and a second printing layer composed of translucent ink. Compared with the prior art, the invention changes the materials and thicknesses of the first and second printing layer of the optical recording medium, so that the drying time of ink can be reduced efficiently. Thus, the whole competitiveness of the product can be enhanced to attract customers, so the sales volume of the manufacture can increase.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An optical recording medium, comprising:
a substrate;
a reflective layer, which is disposed above the substrate;
a first printing layer, which is disposed above the reflective layer; and
a second printing layer, which is disposed above the first printing layer, wherein the first printing layer and the second printing layer comprise translucent ink and the first printing layer further comprises white ink.

2. The optical recording medium of claim 1, wherein the white ink at least comprises acrylate, TMPTA (trimethylolpropane triacrylate), TPGDA (tripropyleneglycol diacrylate), and benzoin ether.

3. The optical recording medium of claim 1, wherein the translucent ink at least comprises acrylic, urethane acrylate, ether, and aliphatic cyclic monomer.

4. The optical recording medium of claim 3, wherein the translucent ink further comprises a photo initiator.

5. The optical recording medium of claim 1, wherein the white ink is about 50% to 70% of the first printing layer.

6. The optical recording medium of claim 1, wherein the translucent ink is about 30% to 50% of the first printing layer.

7. The optical recording medium of claim 1, wherein the thickness of the second printing layer is larger than 30 μm.

8. The optical recording medium of claim 1, wherein the optical recording medium is a CD-ROM, a CD-R, or a CD-RW.

9. The optical recording medium of claim 1, wherein the optical recording medium is a DVD-ROM, DVD+/−R, a DVD+/−RW, or a DVD-RAM.
